(19) United States
(12) Patent Application Publication
(10) Pub. No.: US 2018/0295998 A1
(43) Pub. Date: Oct. 18, 2018

(54) DYNAMICALLY ADJUSTABLE ARM LIFT (DAAL) ACCESSORY DEVICE

(71) Applicant: LOCKHEED MARTIN CORPORATION, Bethesda, MD (US)

(72) Inventor: Gavin A. Barnes, St. Cloud, FL (US)

(21) Appl. No.: 15/487,527

(22) Filed: Apr. 14, 2017

(51) Int. Cl. A47C 16/00; F16M 13/04

(52) U.S. Cl. CPC A47C 16/00; F16M 2200/041; F16M 2200/06; F16M 13/04

(57) ABSTRACT

A device comprising an arm cradle being configured to support and cradle a portion of an arm. The arm cradle includes a first side and a second side. The first side includes a matrix of selectable connector points comprising at least one selectable connector point in proximity to the front end of the cradle, at least one selectable connector point in proximity to a center of the cradle and at least one selectable connector point in proximity to a rear end of the cradle. A bracket having a first coupling member removably coupled to a selectable connector point and a second coupling member. An elevator post has a first end and second end. The first end is coupled to the second coupling member such that the bracket swivels about the first end automatically as the arm moves. A system and method are also provided.

### BACKGROUND

Embodiments relate to arm braces and specifically a dynamically adjustable arm lift (DAAL) accessory device.

The lower extremity exoskeleton (LEE) systems are used for supporting heavy tools and loads carried by a user. In some instances, the LEE system can be used to support heavy tools used by a user to perform a task. When the LEE systems are used to support a heavy tool, a dynamic assist support (DAS) arm may be used to support the weight of the tool. For example, a gimbaled tool support system has been developed which attaches to the DAS arm to directly support a tool from a free end of the DAS arm. The tool is required to be large enough to provide an area for the gimbals to hold onto while also allowing a user to hold onto a portion of the gimbaled tool at the end of the DAS arm. However, some tools are customized for use with the gimbaled tool support system or the DAS arm. In other instances, additional structures are needed to retrofit existing tools so that the tool can be attached to or interfaced with the DAS arm or a gimbaled tool support system. The structures to retrofit tools may increase the weight of the tool and/or may make the tool cumbersome to use.

The gimbaled tool support system still does not assist the user's muscles when performing certain jobs with their arms elevated for extended periods of time.

### SUMMARY

Embodiments relate to a dynamically adjustable arm lift (DAAL) accessory device, a system and a method. An aspect of the embodiments includes a device comprising an arm cradle having a front end, rear end and longitudinal length extending from the front end to the rear end. The arm cradle is configured to support and cradle a portion of an arm of a user. The arm cradle includes a first side and a second side including a matrix of selectable connector points, the matrix of selectable connector points comprising at least one selectable connector point in proximity to the front end of the cradle, at least one selectable connector point in proximity to a center of the cradle and at least one selectable connector point in proximity to a rear end of the cradle. The device includes a bracket having a first coupling member removably coupled to a selected connector point of the matrix of selectable connector points and a second coupling member. An elevator post has a first end and a second end. The first end is coupled to the second coupling member such that the bracket swivels about the first end automatically as the arm moves about a shoulder joint of the user.

An aspect of the embodiments includes a system comprising an exoskeleton system and a dynamically adjustable arm lift (DAAL) accessory device coupled to and supported from the exoskeleton system. The DAAL accessory device comprises an arm cradle having a front end, rear end and longitudinal length extending from the front end to the rear end and being configured to support and cradle a portion of an arm of a user. The arm cradle includes a first side and a second side including a matrix of selectable connector points. The matrix of selectable connector points comprises selectable connector points arranged from the front end to the rear end of the cradle. A bracket has a first coupling member removably coupled to a selected connector point of the matrix of selectable connector points and a second coupling member. An elevator post is swivelly coupled to the bracket via the second coupling member to swivel the cradle as the arm moves about a shoulder joint of the user.

Another aspect of the embodiments includes a method comprising: attaching a dynamically adjustable arm lift (DAAL) accessory device to a primary support system, the DAAL accessory having a dynamically adjustable arm cradle to support an arm of a user in an elevated position from an elevator post bracketed, via a bracket, to a selectable connector point on the arm cradle; automatically adjusting vertically the arm cradle as a function of a force exerted by the arm of the user in the arm cradle; automatically swiveling the arm cradle about the elevator post in response to following movement left or right of the arm of the user about a shoulder joint of the user; and automatically pivoting a front end of the arm cradle relative to a rear end of the arm cradle or balance the front end relative to the rear end of the arm cradle about the connector point.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 illustrates a view of components of a dynamically adjustable arm lift (DAAL) accessory device with a biasing spring shown in phantom;

FIG. 2 illustrates a lateral side view of the DAAL accessory device;

FIG. 3 illustrates a medial side view of the DAAL accessory device;

FIG. 4 illustrates a perspective view of the DAAL accessory device;

FIG. 5 illustrates a view of components of another embodiment of the DAAL accessory device;

FIG. 6A illustrates a perspective view of the DAAL accessory device at a rotated position;

FIG. 6B illustrates a view of a base rotation coupler in a first position;

FIG. 6C illustrates a view of the base rotation coupler in a second position;

FIG. 7A illustrates a lateral side view of the DAAL accessory device installed on a lower extremity exoskeleton system worn by a user;

FIG. 7B illustrates a lateral side view of the DAAL accessory device installed on a harness system worn by a user;

FIG. 7C illustrates a lateral side view of the DAAL accessory device installed on a belt system worn by a user; and

FIG. 8 illustrates a flowchart of a method of supporting an arm using the DAAL accessory device.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

The forearm of the human extremity extends from the wrist of the arm to the elbow. The forearm includes extensors and flexors to extend and flex the wrist, for example. The forearm also includes other muscles to control the hands such as an abductor to control movement of the thumb, by way of non-limiting example. The forearm muscles serve to allow the forearm to rotate the wrist, as well.

The upper arm of the human extremity extends from the elbow to the shoulder. The upper arm includes various muscles such as triceps and biceps. The bicep flexes the arm at the elbow. The triceps provide for extension of the arm at the elbow, by way of non-limiting example. Specifically, the upper arm allows a person to pull objects and lift objects according to the strength of the user. The upper arm may hang generally parallel to the longitudinal axis of the body. When the arm hangs and is not holding a weight, the muscles of the upper arm are generally in a relaxed, inactive or resting state. However, when the arm is elevated or moved in any direction from being parallel to the longitudinal axis, the muscle becomes activated or contracted. The muscles remain contracted to maintain the non-resting state or provide additional movement, otherwise the arm may fall back to its resting state.

A person may begin to feel muscle fatigue and eventually pain after a certain length of time a muscle remains in a contracted state. Workers may perform a task with their arm muscles in a contracted state for an extended period of time. The length of time or extended period of time varies person to person for various reasons. Moreover, the length of time shortens when the person is holding a free weight in their hand while simultaneously elevating or contracting their muscles. For example, a hand-held tool may act as a free weight.

The elbow is an anatomically hinged joint which allows the forearm to move relative to the upper arm. For example, the elbow allows the forearm to pivot from a position which orients the forearm substantially parallel to the upper arm by up to substantially 180 degrees, such as when the forearm is fully extended. The elbow has an outer bony prominence or lateral epicondyle. The elbow also includes a bony prominence on an inner or medial side of the elbow. The bony prominence on the inner or media side is the medial epicondyle.

The dynamically adjustable arm lift (DAAL) accessory device provides an accessory device for use with lower extremity exoskeleton system, other exoskeleton systems or primary support systems. The exoskeleton may include powered or non-powered lower extremity exoskeleton systems. The term powered includes any power mechanism, including battery power, hydraulically powered, pneumatically powered or fluid powered which assists in the movement of the exoskeleton system in addition to or in lieu of human strength.

The DAAL accessory device is configured to support portions of the user's arm while elevating and simultaneously supporting the arm and dynamically adjust to the arm's movement in a manner which allows the arm's muscle to remain in a contracted state longer than would be permitted if the DAAL accessory device is not in use.

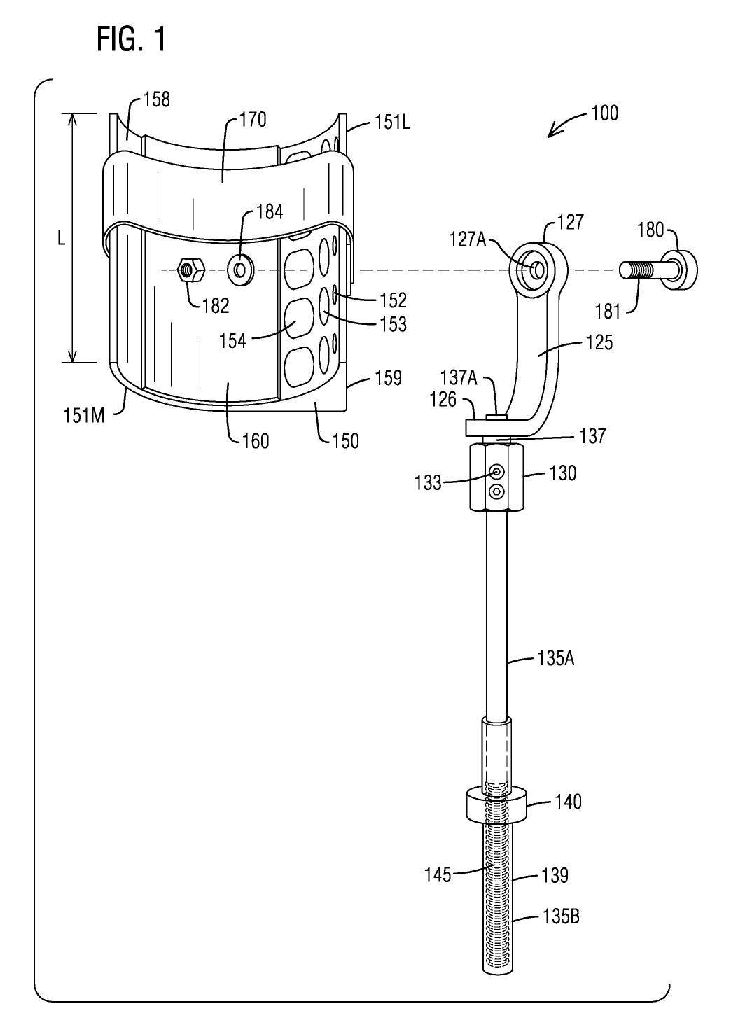

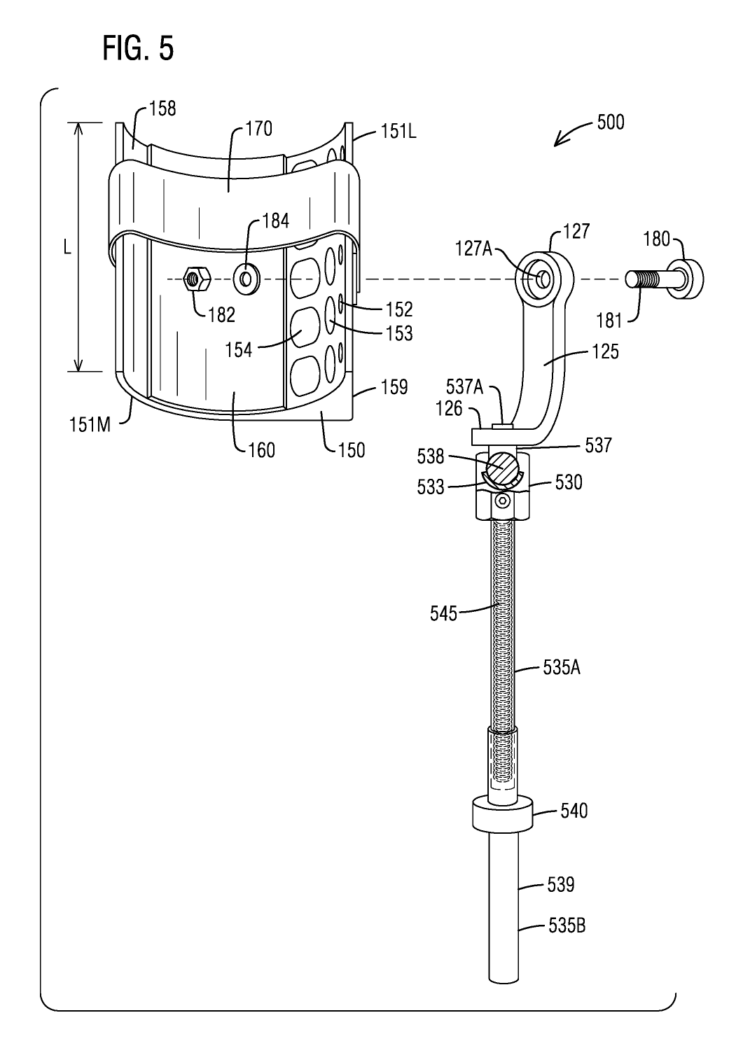

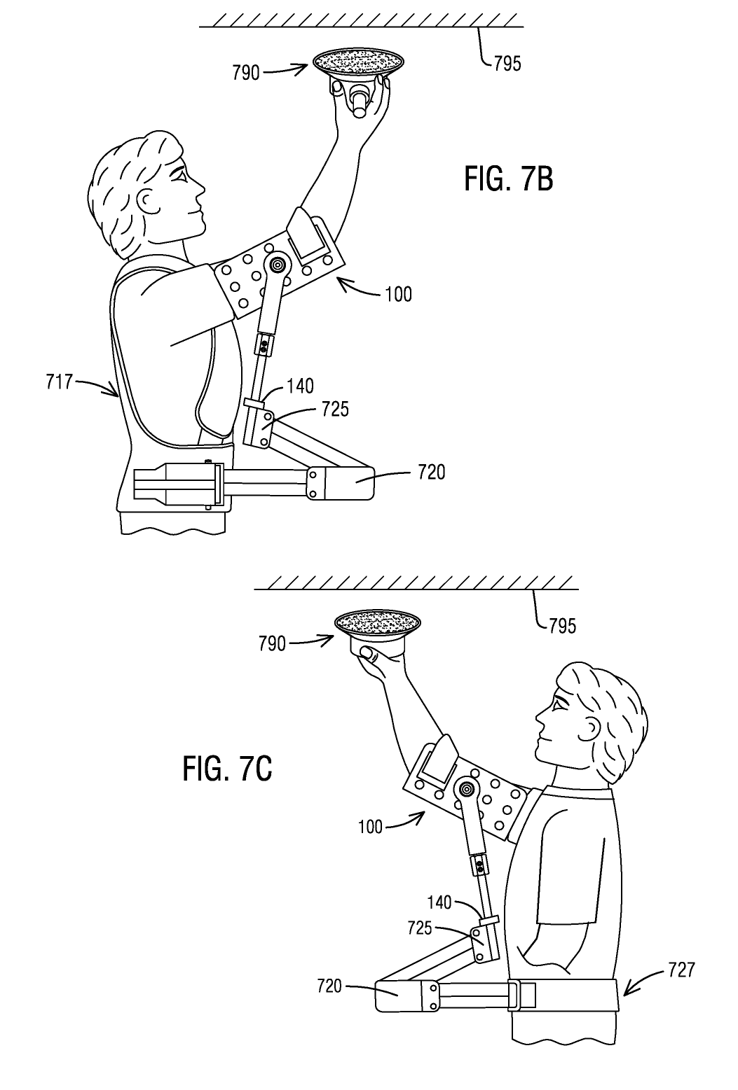

FIG. 1 illustrates a view of components of the dynamically adjustable arm lift (DAAL) accessory device 100 with a biasing spring 145 shown in phantom. The DAAL accessory device 100 will also be described in relation to FIG. 4 which includes a perspective view of the DAAL accessory device 100. The DAAL accessory device 100 may comprise an arm cradle 150 having a longitudinal length L configured to support a portion of the arm length of an upper arm of a user, as best seen in FIG. 7A. The dynamic adjustability features of the DAAL accessory device 100 allows the device 100 to be used to support and hold elevated the upper portion of the arm of the user during a task being performed by a hand-held tool held in the hand of the user while maintaining the wrist of the user unencumbered and free to move, rotate and flex. The DAAL accessory device 100 is unpowered and provides a mechanism to support in an elevated or lifted stance the upper arm portion or the forearm portion of the arm, such as while the user is holding and using a hand-held tool to perform a task, as will be described in more detail in relation to FIGS. 7A-7C.

The arm cradle 150 may include a lateral side 151L and a medial side 151M. The lateral side 151L includes a matrix of selectable connector points 152, 153 and 154. The matrix of selectable connector points 152, 153 and 154 allows multiple points of adjustment to accommodate the person's body size and height, specifically in relation to the object a task is to be acted on by the user. The selectable connector points 152, 153 and 154 may be adjusted such as based on the specific task to be performed. The matrix may include a plurality of points in a single row, a plurality of points in a single column, or a plurality of points in a plurality of rows and columns.

The DAAL accessory device 100 may include a cushion lining 160 attached to the interior surface 158 of the arm cradle 150. The lining 160 may include a pad made of deformable material or cushioning material. In some embodiments, the deformable material may provide a top friction surface on which the elbow and/or arm portion would rest to limit slippage of the arm portion. The cushion lining 160 may provide a cushioned surface to protect the elbow's outer bony prominences such as the lateral and medial epicondyles.

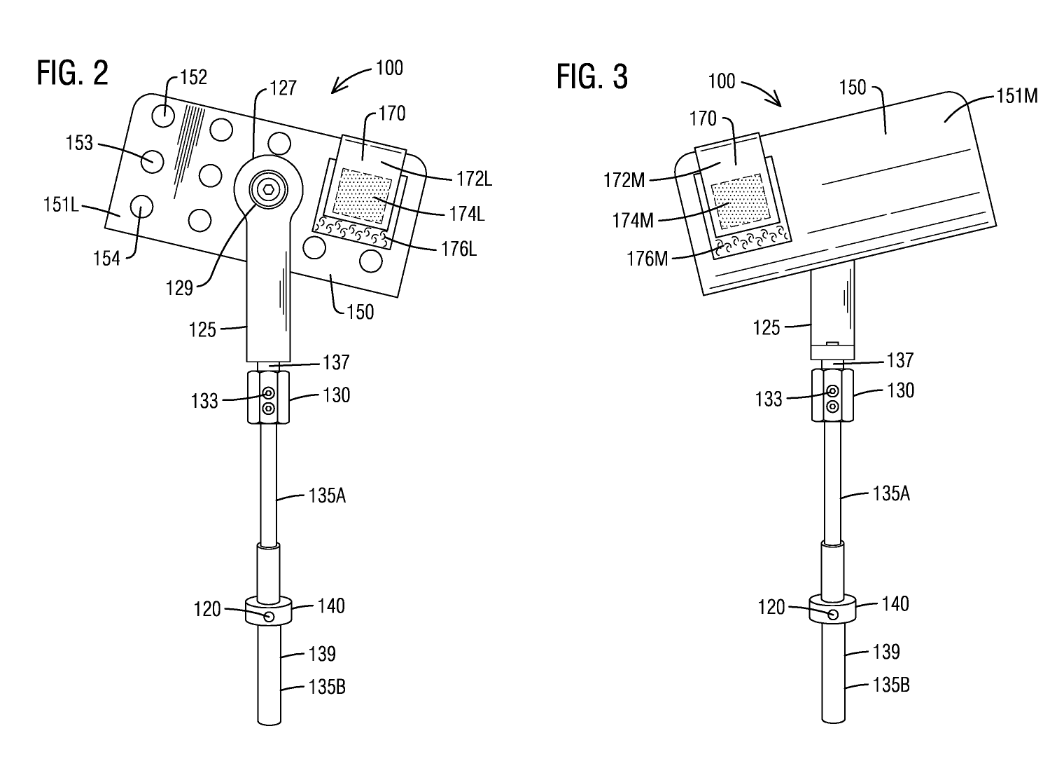

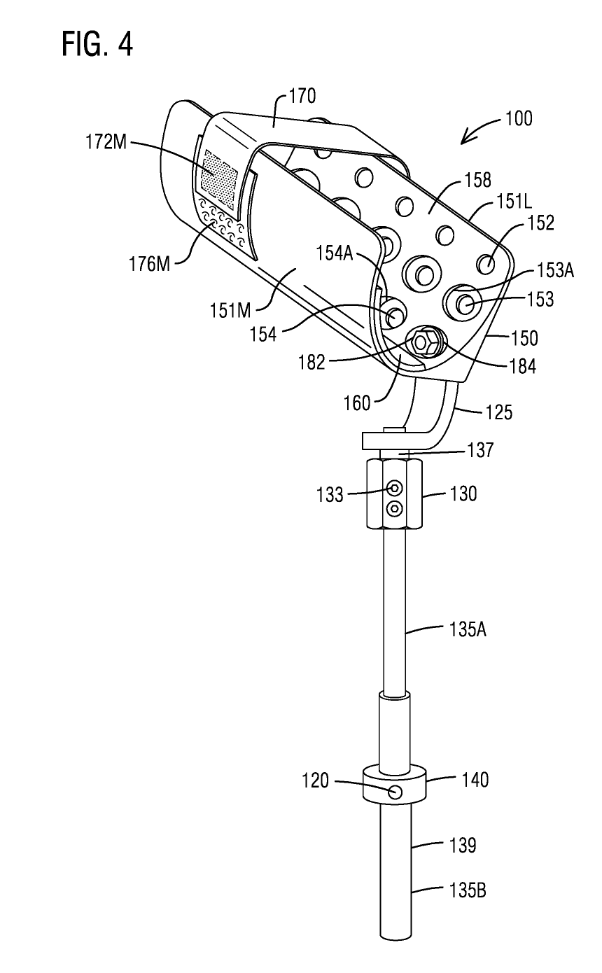

Referring also to FIGS. 2 and 3, a lateral side view and a medial side view of the DAAL accessory device 100 are shown. The DAAL accessory device 100 may include a band 170 having a first (lateral) band side 172L coupled to a first location on the lateral side 151L of the arm cradle 150. The band 170 may include a second (median) band side 172M coupled to a second location on a medial side 151M of the arm cradle 150. The first location and the second location may be diametrically opposing wherein the band 170 may be configured to hold or strap a portion of the user's arm in the arm cradle 150.

In some embodiments, the band 170 is configured to strap around the arm in proximity to the elbow such as when securing the upper arm in the cradle 150. Alternately, the band 170 is configured to strap around the arm in proximity to the elbow such as when securing the forearm in the cradle 150. The band 170 may strap around the arm just above the elbow crease, by way of non-limiting example, such as when attaching the arm cradle 150 to the upper arm. The band 170 may strap onto the arm just below the elbow crease, by way of non-limiting example, such as when attaching the arm cradle 150 to the forearm. Nonetheless, the band 170 may be strapped to the user's arm at other locations such as according to the comfort of the user or as a function of the support and lifting action of the DAAL accessory device 100.

The band 170 allows the triceps and biceps to be unencumbered when the upper arm or forearm are cradled in cradle 150. Thus, the strength of the user may be preserved to hold the hand-held tool including over long or extended periods of time.

While the band 170 is shown passing over the top edges of the front end of the cradle 150, diametrically opposing and aligned slots may be formed in the cradle's side walls to thread a strap of the band 170 through such slots. In some embodiments, the band 170 may be made of elastic material.

The first (lateral) side 172L of the band 170 may be fastened to the first location on the cradle 150 via hook and loop fasteners 174L, 176L. The second (median) side 172M of the band 170 may be fastened to the second location on the cradle 150 via hook and loop fasteners 174M, 176M. The hook and loop fasteners 174L, 176L, or 174M, 176M may include hook and loop fasteners by Velcro®.

Referring still to FIGS. 1-3, the DAAL accessory device 100 may comprise a bracket 125. The bracket 125 may have a generally L-shape or half of a U-shape. The half of a U-shape comprises a generally L-shape, but the intersection of the two legs of the L shaped bracket is joined to form a generally right angle corner wherein the corner may be generally rounded.

The upper free end of the vertical leg segment of the bracket 125 may include a pivot coupling member 127 removably coupled to one of the selectable connector points of the matrix of selectable connector points 152, 153 and 154. The bracket 125 may include a swivel coupling member 126 at a free end of the generally horizontal leg segment of the bracket 125. It should be noted that the terms “vertical” and “horizontal” are relative terms such that the legs of the bracket 125 may vary as the DAAL accessory device 100 is adjusted relative to the vertical plane and the horizontal plane. In some instance, the vertical leg segment of the bracket 125 may be a first leg segment and the horizontal leg segment may be a second leg segment.

The upper end 127 may include an aperture 127A for the receipt of fastener 180. The fastener 180 may include a bolt or screw having a shaft 181 and fastener head wherein a portion of the shaft 181 is threaded. The non-threaded portion allows the fastener 180 to pivot about the unthreaded portion of shaft 181. The fastener 180 may be fastened to one of the selectable connector points 152, 153 and 154 via a nut 182. In some embodiments, a washer 184 may be used. By way of non-limiting example, the fastener 180 is a shoulder bolt. Nonetheless, other types of pivoting mechanisms may be used. In FIG. 4, the fastener may be received through the pivot interface 129 of the upper end 127, as best seen in FIG. 2. In other words, when the user is working, the arm cradle 150 is configured to automatically pivot or rotate as the user's arm is raised and lowered. By way of non-limiting example, the pivotal or swivel interfaces described herein may provide gimbaled actions of the cradle with respect to the first elevating post member 135A.

The arm cradle 150 may include an interior surface 158 having a generally U-shaped curvature to cradle a portion of the user's arm supported and rested within the U-shaped curvature. The arm cradle 150 may include an exterior surface 159 having a medial side 151M which tracks the U-shaped curvature, as best seen in FIGS. 1 and 4. In general, the wall thickness of the medial side 151M may be generally the same between the exterior surface 159 and the interior surface 158.

The width of the U-shaped curvature may be the same along the length L of the arm cradle 150 from the front end to the rear end. However, in some embodiments, the width of the U-shaped curvature may vary such that the width of the front portion of the length L of the cradle 150 may be narrower than the width of the rear portion of the cradle 150.

The wall thickness of the lateral side 151L between the exterior surface 159 and interior surface 158 varies such that the wall thickness at the bottom end, as best seen in FIG. 1, is greater than at the thickness at the top end. The wall thickness is varied such that the wall defined by the lateral side 151L along the interior surface 158 tracks a U-shaped curvature. The exterior surface 159 may be generally straight or linear from the top edge to the bottom edge. The medial side 151M generally curves to follow a U-shaped arc of the interior surface 158. By way of non-limiting example, the straight wall is used for the attachment of the bracket 125 via fastener 180.

The DAAL accessory device 100 may comprise a first elevating post member 135A. In some embodiments, the first elevating post member 135A is telescopically coupled to a support coupling interface 139. The support coupling interface 139 may include a second elevating post member 135B telescopically interfaced with the first elevating post member 135A. By way of non-limiting example, a free end of the first elevating post member 135A may be received in a top end of the support coupling interface 139. The first elevating post member 135A may be spring biased to the second elevating post member 135B. The spring biasing, in some embodiments, may add to the cushioning effect of the cradle 150 when the arm is rested and supported in the cradle 150.

Furthermore, as the user performs a task and moves around, the telescopic interface may allow the length of the first elevating post member 135A to automatically adjust via a spring force action of spring 145 such that the combined length of the first elevating post member 135A and the second elevating post member 135B is shortened when a force greater than the spring force of spring 145 is applied downward on the cradle 150. The spring biasing force may be configured to prevent full compression of the spring 145 under the added weight of the free weight of the hand-held tool. In other words, the resiliency of the spring biasing force should be maintained with the added free weight.

Furthermore, as the user performs a task and moves around, the telescopic interface may allow the length of the first elevating post member 135A to automatically adjust via a spring force action of spring 145 such that the combined length of the first elevating post member 135A and the second elevating post member 135B is lengthened as the force applied on the cradle 150, as translated to the biasing spring 145, lessens.

In some embodiments, the biasing spring 145 may extend from the free end of the first elevating post member 135A to a bottom of the second elevating post member 135B or a plate in the second elevating post member 135B.

In some embodiments, the first elevating post member 135A and the second elevating post member 135B may be telescopically coupled in a rigid manner such that the combined length of the first elevating post member 135A and the second elevating post member 135B may be adjusted to a selected length and locked to such selected length to accommodate a person's structure. In some embodiments, the combined length of first elevating post member 135A and the second elevating post member 135B may be fixed.

The first elevating post member 135A may include a swivel end member 130. The swivel end member 130 may be coupled to an end of the first elevating post member 135A opposite that of the free end interfaced to the second elevating post member 135B. The swivel end member 130 includes a swivel post 137 coupled to the swivel coupling member 126 of bracket 125. The swivel post 137 rotates or swivels the arm cradle 150 in an aperture (NOT SHOWN) through which a swivel pin 137A is coupled. The bracket 125 swivels about the swivel post 137. The bracket 125 may swivel left automatically as the cradled arm moves left about a shoulder joint of a user and alternately automatically swivel right when the cradled arm moves right about the shoulder joint. The swivel end member 130 is coupled to the first elevating post member 135A via fasteners 133.

The support coupling interface 139 may comprise an interface coupler 140 coupled to the second elevating post member 135B. The interface coupler 140 is positioned on the second elevating post member 135B such that a length of the post member 135B can be received in a mount of a secondary support system. By way of non-limiting example, the secondary support system may include a dynamic assist support (DAS) arm. In some embodiments, the interface coupler 140 may include a locking pin 120 configured to lock the interface coupler 140 in or to a mount of the secondary support system.

In some embodiments, the support coupling interface 139 may be interchangeable such that the support coupling interface 139 would house the biasing spring 145. The interchangeable support coupling interface 139 may be interchanged with another support coupling interface 139 for a different biasing spring 145 to support the weight of a free weight object or tool held in the hand of the user. The support coupling interface 139 may be interchanged based on the interface coupler 140. While the support coupling interface 139 is described for use with a dynamic assist support (DAS) arm, other interface couplers (i.e., coupler 140) may be required for connection to other primary support systems. The interchangeability of the support coupling interface 139 allows the DAAL accessory device 100 to be used or interfaced with a variety of primary support systems. The interface couplers may include threaded ends, snap-on connections, other fasteners including screws or bolts, etc.

The first elevating post member 135A and the second elevating post member 135B may be made of metal, steel, plastic or other rigid and durable material compositions.

Referring now to FIG. 4, the interior side of the lateral side 151L includes a recessed cavity around one or more of the selectable connector points 152, 153 and 154. The selectable connector points 152, 153 and 154 may include one or more rows of selectable connector points, wherein each row may have one or more selectable connector points. By way of non-limiting example, the cavity 154A around a respective one connector point 154 of a bottom row is deeper than the cavity 153A around connector point 153 of a middle row. The cavities may be dimensioned to receive the diameter of washer 184 and nut 183. The cavities 154A and 153A may house or recess the nut 183 so that the nut 183 does not cause discomfort to the user when their arm is cradled in cradle 150 and/or protect the elbow's outer bony prominences such as the lateral and medial epicondyles or other cradled portions of the arm.

In some embodiments, the cushion lining 160 may extend on the interior surface 158 along the lateral side 151L with holes or openings which align with the selectable connector points 152, 153 and 154 and/or the cavities 154A and 153A.

In the representation of FIG. 4, the cradle 150 is oriented such that the elevation of the front end (the end with band 170) is above the elevation of the rear end (opposite the front end). In the representation of FIGS. 2 and 3, the cradle 150 is oriented such that the elevation of the front end (the end with band 170) is lower than the elevation of the rear end (opposite the front end). It should be noted that the selection of one of selectable connector points 152, 153 and 154 in the middle of the lateral side 151L may be used to balance the cradle such that maintaining the front end and the rear end at generally the same relative elevation may be easier during use. Selecting a connector point 151, 153, and 154 closer to the front end of the cradle 150 may cause the rear end of the cradle 150 to easily maintain a lowered elevation with respect to the front end during the task. Selecting a connector point 151, 153, and 154 closer to the rear end of the cradle 150 may cause the front end of the cradle 150 to easily maintain a lowered elevation with respect to the rear end. Nonetheless, the pivoting action by the pivot interface 129 may cause the cradle 150 to see-saw about the pivot interface 129 or follow the user's arm motion while performing a task in the lifted or elevated posture of the arm portion in the cradle 150. The pivoting or following action of the cradle 150 is effected by a distribution of force (or weight) exerted on the cradle caused by at least the arm of the user or arm and hand-held tool held by the user. In some embodiments, the pivot interface 129 may include a spring mechanism to limit the pivot motion of the cradle 150 when supporting the user's arm.

In some embodiments, the cradle body of cradle 150 may be weighted to cause the front end to tend to maintain an elevated position above the rear end. Alternately, the cradle body of cradle 150 may weighted to cause the rear end to tend to maintain an elevated position above the front end of the cradle. In some embodiments, the cradle body of the cradle 150 may be weighted so that the distributed weight of the cradle 150 is balanced along the length L.

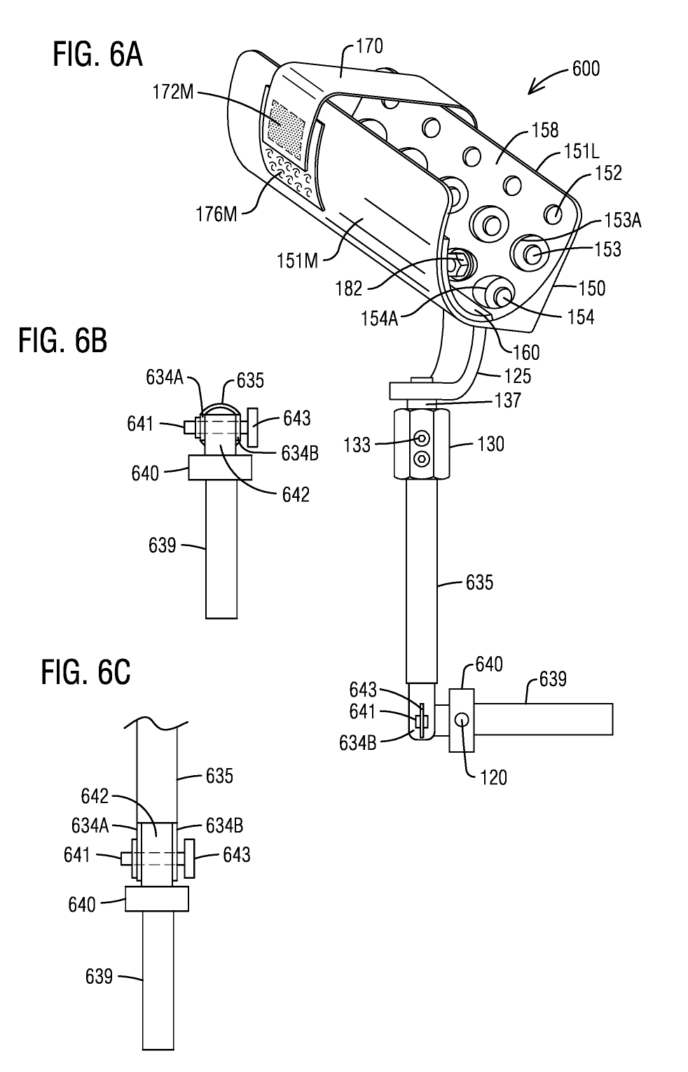

FIG. 5 illustrates a view of components of another embodiment of the DAAL accessory device 500. The DAAL accessory device 500 is similar to device 100. Therefore, for the sake of brevity, only the differences will be described in detail wherein like reference numerals refer to like parts. The DAAL accessory device 500 includes a ball joint 538 cradled in an internal cradle 533 of swivel end member 530. The swivel post 537 has one end coupled to the ball joint 538 and another end coupled to pin 537A. The ball joint 538 may provide additional flexibility as the user naturally moves their arm while holding the hand-held tool and performing the task.

In some embodiments, the first elevating post member 535A and the second elevating post member 535B may be telescopically coupled together. In an embodiment, the biasing spring 545 extends from the swivel end member 530 of the first elevating post member 535A to a plate or stop in the second elevating post member 535B at a location above the interface coupler 540 of support coupling interface 539. Nonetheless, a bottom end of the second elevating post member 535B may provide a stop.

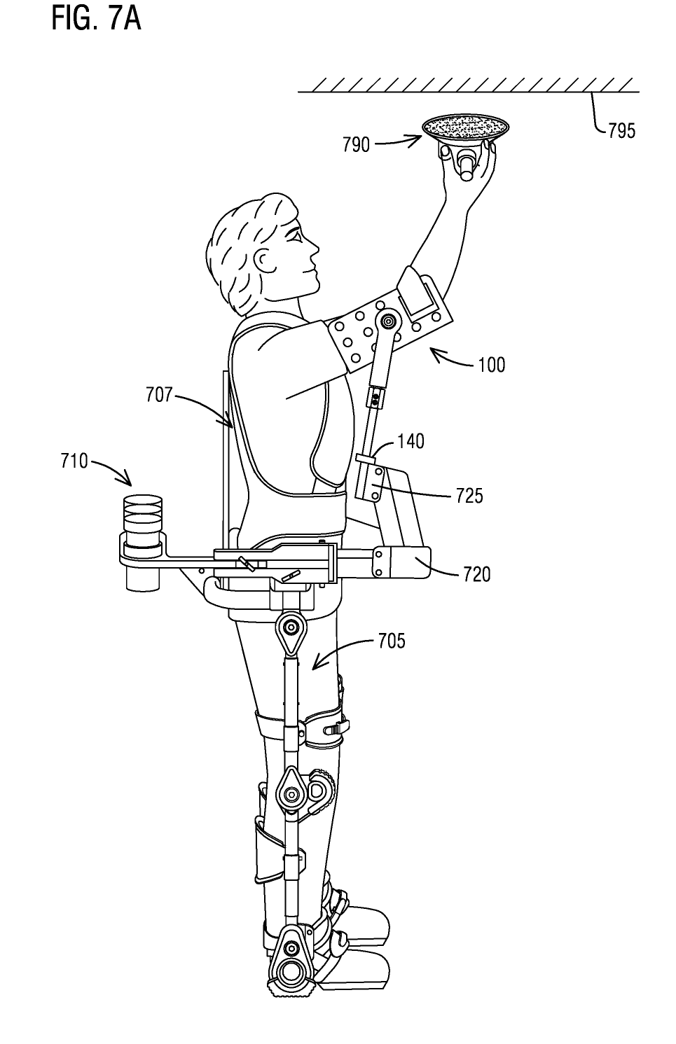

FIG. 6A illustrates a perspective view of the DAAL accessory device 600 at a rotated position. The DAAL accessory device 600 is similar to device 100 or 500. Therefore, for the sake of brevity, only the differences will be described in detail wherein like reference numerals refer to like parts. The first elevating post member 635 may include a forked free end having fork members 634A (FIGS. 6B and 6C) and 634B. The fork members 634A (FIGS. 6B and 6C) and 634B, each including a hole for receipt of a locking pin 641 having a locking pin handle 643. In a first orientation, the locking pin 641 locks the first elevating post member 635 to the support coupling interface 639 in a horizontal or first position, as shown in FIGS. 6A and 6B. In a second orientation, the locking pin 641 locks the first elevating post member 635 to the support coupling interface 639 in a vertical or second position, as shown in FIG. 6C. The second position of the first elevating post member 635 is oriented approximately 90 degree offset from the orientation of the first elevating post member 635 in the first position.

The support coupling interface 639 includes a shaft 642 above the interface coupler 640 and includes a through hole for receipt of the locking pin 641. The locking pin 641 extends through a first fork member though the shaft 642 and through the second fork member. The locking pin 641 may include a lock or fastener to keep the locking pin 641 in place during operation.

While not shown, the first elevating post member 635 may be configured to be telescopic and/or spring biased such that the length of the first elevating post member 635 may be split to provide telescopic lengthening. In some embodiments, the locking pin 641 may include a square rod to prevent rotation of the first elevating post member 635 with respect to a longitudinal axis of the support coupling interface 639, when locked in the first position or the second position. The locking pin 641 may include a head or handle 643 to remove the locking pin 641 wherein removal of the locking pin 641 allows the first elevating post member 635 to be detached and reattached to the shaft 642. Other locking pin or fastening mechanisms may be used to attach and reattach the first elevating post member 635.

In some embodiments, the fork members 634A (FIGS. 6B and 6C) and 634B, a hole for receipt of a locking pin 641, and locking pin 641 with head or handle 643, for example, provide a bend coupler for the first elevating post member 635. For example, the first elevating post member 635 may include a bend in lieu of removable parts (e.g., locking pin) to provide a bend in the range of 0-90 degrees or other angles with respect of the support coupling interface 639. Moreover, the first elevating post member 635 may include one or more bends to position the user's arm at a certain location elevated in space.

In some embodiments, the first elevating post member 635 may be removable and replaced with another first elevating post member 635 with one or more bends of different degrees so that the arm of the user can be elevated at a certain location elevated in space. Moreover, the length of the first elevating post member 635 may be adjusted with a removable elevating post member 635.

FIG. 7A illustrates a lateral side view of the DAAL accessory device 100 installed on a primary support assembly 705 such as, without limitation, a lower extremity exoskeleton (LEE) system, worn by a user. In this example, the cradle is attached to the upper arm and the front end of the cradle is oriented at an elevation which is higher than the rear end of the cradle.

The DAAL accessory device 100 is attached to a dynamic assist support (DAS) arm 720 via arm interface 725. The DAS arm 720 is balanced via balancing mechanism 710 around the back of the user. In some embodiments, the DAS arm 720 is resilient and flexible to allow the DAAL accessory device 100 to be dynamically supported and adjusted in space relation to the user's body or LEE system. For some tasks, the elevation post member may be fixed in length without telescopic properties. The primary support assembly 705 may comprise a harness 707 coupled to or integrated with the lower extremity exoskeleton system. The band (i.e., band 170) catches on the folded forearm of the user to prevent the DAAL accessory device 100 from slipping forward and/or off during operation. Nonetheless, in some embodiments, the forearm may be cradled in cradle (i.e., cradle 150). In some embodiments, the DAS arm 720 may be substituted with other support members which are not dynamically flexible. In such instances, a telescopic elevation post may be used.

By way of non-limiting example, the user may perform a task on a surface which is above the user's head using a hand-held tool. As can be appreciated, continued elevation of a user's arm may cause muscle fatigue and, in some instances, muscle strain or injury. The muscle fatigue may be experienced more quickly when the user is holding a weighted object for prolonged or extended periods of time. Thus, the DAAL accessory device 100 helps support the weight of both the user's arm and the tool. In the example, the user is sanding a ceiling 795.

As can be appreciated, each and every orientation of the DAAL accessory device 100 when in use is prohibitive. In some instances, for example, the user may be performing a task with a hand-held tool which would require, by way of non-limiting example, the user's hand to be below the head, below the chin or below the waist such as when the user is standing. In a lying down position, the user's hand would be above the plane of the body. The DAAL accessory device 100 is dynamically and universally adjustable to allow one of the user's forearm or upper arm to be supported, lifted, and/or elevated in space and in a manner which reduces muscle strain while performing a task while using a hand-held tool. The hand-held tool may be powered or unpowered. The hand-held tool requires no adaptations for the use of the tool and is commercially available off the shelf.

The band (i.e., band 170) is shown as wrapped around the top portion of the circumference of the arm. However, in some embodiments, a band or sling may be used to wrap circumferentially around the back of the upper arm and around the elbow when the device 100 is used in certain positions, such as similar to a sling. In some embodiments, a different length band may be used and may selectively attach to the cradle at the same locations as band 170, as shown in FIGS. 2 and 3 using hook and loop fasteners. Nonetheless, the cradle may include additional fasteners to attach an additional band including, but not limited to, buckles, snaps, buttons, straps, etc. By way of non-limiting example, the rear end of the cradle may include slots for the selective attachment of a strap that would be wrapped around the back of the upper arm in proximity to the elbow.

FIG. 7B illustrates a lateral side view of the DAAL accessory device 100 installed on a torso harness system 717 worn by a user. In this example, the primary support assembly may comprise a harness system 717. The cradle is attached to the upper arm and the front end of the cradle is oriented at an elevation which is higher than the rear end of the cradle.

The DAAL accessory device 100 is attached to a dynamic assist support (DAS) arm 720 via arm interface 725.

FIG. 7C illustrates a lateral side view of the DAAL accessory device 100 installed on a belt system 727 worn by a user. In this example, the primary support assembly may comprise a belt system 727. The cradle is attached to the upper arm and the front end of the cradle is oriented at an elevation which is higher than the rear end of the cradle.

In some embodiments, the primary support assembly may use a different support structure in lieu of a dynamic assist support arm.

In some embodiments, the DAAL accessory device 100 has application for use with a hand-held tool which is lightweight such as, may be 5 lbs. (pounds) or less. The hand-held tool may be a single-handed tool such as a drill, sander, wrench, etc.

In some embodiments, the user may be in a reclined position such as lying on their back while performing a job which requires their arms to be elevated in space above their body. The DAAL accessory device 100 will elevate, support and/or lift the user's arm in space.

In operation, the DAAL accessory device allows the user to use hand-held tools as before, but now gains additional physical support such as when using an exoskeleton system. Moreover, in some embodiments, the cradle 150 automatically adjusts vertically as the user raises and lowers their arm or reduces a downward force on the spring. The cradle 150 also automatically pivots or swivels left or right about a top end of the first elevating post member 135A, as the arm moves naturally, while simultaneously providing elevational or lifting support of the arm. The front end of the cradle 150 also automatically pivots up and down about the bracket to change the elevational profile of the arm to lean up or down as the arm moves naturally, as the first elevating post member 135A simultaneously provides elevational or lifting support of the arm.

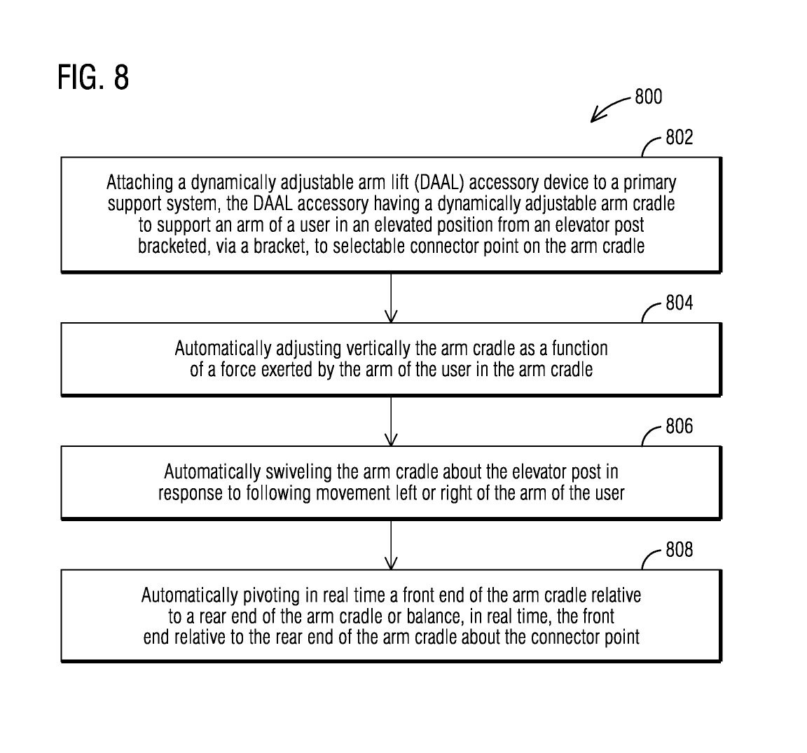

FIG. 8 illustrates a flowchart of a method 800 of supporting an arm using the DAAL accessory device will now be described in detail. The method will be described in relation to FIGS. 1-4. However, the method can be performed by any of the DAAL devices described herein. The method blocks herein may be performed in the order shown, in a different order or contemporaneously. One or more steps or blocks may be added or deleted. The method 800 may include, at block 802, attaching a dynamically adjustable arm lift (DAAL) accessory device 100 to a primary support system 705. The DAAL accessory device 100 has a dynamically adjustable arm cradle 150 to support an arm of a user in an elevated position from an elevator post (i.e., elevating post member 135A) bracketed, via a bracket 125, to a selectable connector point on the arm cradle 150.

The method 800 may include, at block 804, automatically adjusting vertically the arm cradle 150 as a function of a force exerted by the arm of the user in the arm cradle 150. The method 800 may include, at block 806, automatically swiveling the arm cradle about the elevator post in response to following movement left or right of the arm of the user. The method 800 may include, at block 808, automatically pivoting in real time a front end of the arm cradle 150 relative to a rear end of the arm cradle 150 or balance, in real time, the front end relative to the rear end of the arm cradle about the connector point.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another.

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

I/We claim:

1. A device comprising:
an arm cradle having a front end, rear end and longitudinal length extending from the front end to the rear end and configured to support and cradle a portion of an arm of a user, the arm cradle including a first side and a second side including a matrix of selectable connector points, the matrix of selectable connector points comprising at least one selectable connector point in proximity to the front end of the cradle, at least one selectable connector point in proximity to a center of the cradle and at least one selectable connector point in proximity to a rear end of the cradle;
a bracket having a first coupling member removably coupled to a selected connector point of the matrix of selectable connector points and a second coupling member; and
an elevator post having a first end and a second end, the first end coupled to the second coupling member such that the bracket swivels about the first end automatically as the arm moves about a shoulder joint.

2. The device according to claim 1, wherein the elevator post is telescopic with a telescopic length.

3. The device according to claim 2, wherein the elevator post is spring biased to automatically adjustably telescope to shorten the elevator post as a force exerted by the arm on the cradle increases and to lengthen the elevator post as the force exerted by the arm on the cradle decreases.

4. The device according to claim 3, wherein the first coupling member of the bracket is pivotally coupled to the arm cradle wherein the device simultaneously:
automatically adjusts vertically the cradle as a function of the force exerted by the arm of the user on the cradle;
automatically swivels the cradle about the first end of the elevator post in response to following movement left or right of the arm of the user; and
automatically pivots the front end of the arm cradle relative to the rear end of the arm cradle or balance the front end relative to the rear end of the arm cradle about the selected connector point of the matrix of selectable connector points.

5. The device according to claim 1, further comprising:
a cushion lining an interior surface of the arm cradle; and
a band having a first band side and a second band side and configured to secure the arm in the cradle, the first band side is coupled to a first location on the first side of the arm cradle and the second band side is coupled to a second location on the second side of the arm cradle, the first location and the second location being diametrically opposing.

6. The device according to claim 1, further comprising:
a support coupling interface coupled to the elevator post, the support coupling interface including a primary support system coupling interface to attach the support coupling interface to the primary support system.

7. The device according to claim 6, wherein the elevator post is configured to be selectively attached to the support coupling interface in one of a first orientation and a second orientation wherein the first orientation is offset from the second orientation by 90 degrees.

8. A system comprising:
an exoskeleton system; and
a dynamically adjustable arm lift (DAAL) accessory device coupled to and supported from the exoskeleton system, the DAAL accessory device comprising:
an arm cradle having a front end, rear end and longitudinal length extending from the front end to the rear end and configured to support and cradle a portion of an arm of a user, the arm cradle including a first side and a second side including a matrix of selectable connector points, the matrix of selectable connector points comprising selectable connector points arranged from the front end to the rear end of the cradle;
a bracket having a first coupling member removably coupled to a selected connector point of the matrix of selectable connector points and a second coupling member; and
an elevator post swivelly coupled to the bracket via the second coupling to swivel the cradle.

9. The system according to claim 8, wherein the elevator post is telescopic with a telescopic length.

10. The system according to claim 8, wherein the elevator post is spring biased to automatically telescope to shorten the elevator post as a force exerted by the arm on the cradle increases and to lengthen the elevator post as the force exerted by the arm on the cradle decreases.

11. The system according to claim 10, wherein the first coupling member of the bracket is pivotally coupled to the arm cradle wherein the DAAL accessory device simultaneously:
automatically adjusts vertically the cradle as a function of the force exerted by the arm of the user on the cradle;
automatically swivels the cradle about the first end of the elevator post in response to following movement left or right of the arm of the user; and
automatically pivots the front end of the arm cradle relative to the rear end of the arm cradle or balance the front end relative to the rear end of the arm cradle about the selected connector point of the matrix of selectable connector points.

12. The system according to claim 8, further comprising:
a cushion lining an interior surface of the arm cradle; and
a band having a first band side and a second band side and configured to secure the arm in the cradle, the first band side is coupled to a first location on the first side of the arm cradle and the second band side is coupled to a second location on the second side of the arm cradle, the first location and the second location being diametrically opposing.

13. The system according to claim 8, further comprising:
a support coupling interface coupled to the elevator post, the support coupling interface including an exoskeleton system coupling interface attaches the support coupling interface to the exoskeleton system.

14. The system according to claim 13, wherein the elevator post is configured to be selectively attached to the support coupling interface in one of a first orientation and a second orientation wherein the first orientation is offset from the second orientation by 90 degrees.

15. The system according to claim 8, wherein the exoskeleton system is powered or unpowered and the DAAL accessory device is unpowered and further comprising a dynamic assist support (DAS) arm coupled to the exoskeleton system wherein the elevator post is coupled to the DAS arm.

16. A method comprising:
attaching a dynamically adjustable arm lift (DAAL) accessory device to a primary support system, the DAAL accessory having a dynamically adjustable arm cradle to support an arm of a user in an elevated position from an elevator post bracketed, via a bracket, to a selectable connector point on the arm cradle;
automatically adjusting vertically the arm cradle as a function of a force exerted by the arm of the user in the arm cradle;
automatically swiveling the arm cradle about the elevator post in response to following movement left or right of the arm of the user; and
automatically pivoting a front end of the arm cradle relative to a rear end of the arm cradle or balance the front end relative to the rear end of the arm cradle about the connector point.

17. The method according to claim 16, wherein the elevator post is telescopic with a telescopic length.

18. The method according to claim 16, wherein the automatically adjusting vertically the arm cradle as the function of the force exerted by the arm of the user in the arm cradle comprises:
spring biasing the elevator post to automatically telescope to shorten the elevator post as the force exerted by the arm on the cradle increases and to lengthen the elevator post as the force exerted by the arm on the cradle decreases.

19. The method according to claim 16, further comprising securing the arm in the arm cradle with a band at a location in proximity to a crease of an elbow.

20. The method according to claim 17, further comprising cushioning the elbow in the arm cradle.
